(19) United States
(12) Patent Application Publication
(10) Pub. No.: US 2022/0171844 A1
(43) Pub. Date: Jun. 2, 2022

(54) SECURE PASSWORD STORAGE SYSTEM AND METHOD

(71) Applicant: Alexander Ehrath, San Marcos, CA (US)

(72) Inventor: Alexander Ehrath, San Marcos, CA (US)

(21) Appl. No.: 17/109,035

(22) Filed: Dec. 1, 2020

(51) Int. Cl. G06F 21/46; G06F 21/35

(52) U.S. Cl. CPC G06F 21/46; G06F 21/35

(57) ABSTRACT

A system for multifactor password creation and provisioning includes a client computing device, a dongle, a computing system, and software configured to perform operations including selecting a website at a user interface of the client computing device, recalling, by the client computing device, an encrypted password from client computing device memory based on the website selection, transmitting, by the client computing device, the encrypted password to the dongle, decrypting, by the dongle, the encrypted password received from the client computing device, transmitting, by the dongle, the decrypted password to the computing system or the client computing device, and entering, by the computing system or client computing device, the decrypted password.

### DESCRIPTION OF THE RELATED ART

Multifactor security for controlling access to computing systems can be performed by requiring credentials and/or hardware to be used in concert. Some software-based multifactor solutions require multiple pieces of information from the user but no additional hardware. However, with the possibility of data being stolen, such systems are less secure than those that incorporate hardware. Other multifactor solutions only require a physical single device (in addition to user data) in order to allow control of a computing system, and as such are especially vulnerable should such a device be lost or stolen.

### SUMMARY

Systems, methods, computer program products are disclosed for encrypting and/or decrypting passwords. In one aspect, a dongle is disclosed that performs operations including decrypting an encrypted password received from a client computing device and transmitting the decrypted password to a computing system or the client computing device.

In some variations, the operations can include writing, to a memory buffer accessible for a copy/paste operation, the decrypted password. The dongle can also receive an unencrypted password from the client computing device and transmit the unencrypted password from the dongle to the computing system. Also, the dongle can encrypt the unencrypted password and transmit the encrypted password to the client computing device.

In some variations, the transmitting can be performed wirelessly or the dongle can be physically connected to the computing system, optionally where the physical connection is via a USB connection and the dongle further comprises a USB plug to facilitate the USB connection.

In an interrelated aspect, a system for multifactor password creation and provisioning includes a client computing device, a dongle, and a computing system. The system performs operations comprising: selecting a website at a user interface of the client computing device, recalling, by the client computing device, an encrypted password from client computing device memory based on the website selection, transmitting, by the client computing device, the encrypted password to the dongle, decrypting, by the dongle, the encrypted password received from the client computing device, transmitting, by the dongle, the decrypted password to the computing system or the client computing device, and entering, by the computing system or client computing device, the decrypted password.

In some variations, the operations further include receiving, at the client computing device via user input, a password configuration, and generating, by the client computing device, an unencrypted password conforming to the password configuration.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also contemplated that may include one or more processors and one or more memories coupled to the one or more processors. A memory, which can include a computer-readable storage medium, may include, encode, store, or the like, one or more programs that cause one or more processors to perform one or more of the operations described herein. Computer implemented methods consistent with one or more implementations of the current subject matter can be implemented by one or more data processors residing in a single computing system or across multiple computing systems. Such multiple computing systems can be connected and can exchange data and/or commands or other instructions or the like via one or more connections, including but not limited to a connection over a network (e.g., the internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to particular implementations, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating an exemplary system for password management for websites accessed via a computing device, in accordance with some aspects of the present disclosure.

FIG. 2 is a diagram illustrating an exemplary process flow chart for an embodiment of the disclosed systems that is configured to provision passwords for use with a website, in accordance with some aspects of the present disclosure.

FIG. 3 is a second diagram illustrating an exemplary process flow chart for an embodiment of the disclosed systems that is configured to provision passwords for use with a website, in accordance with some aspects of the present disclosure.

FIG. 4 is a diagram illustrating an exemplary process flow chart for an embodiment of the disclosed systems that is configured to recall passwords for use with a website, in accordance with some aspects of the present disclosure.

FIG. 5 is a diagram illustrating an exemplary process flow chart for an embodiment of the disclosed systems that is configured to recall passwords for use with a website, in accordance with some aspects of the present disclosure.

FIG. 6 is a diagram illustrating a simplified process flow diagram of an exemplary method, in accordance with some aspects of the present disclosure.

### DETAILED DESCRIPTION

Multi-factor security generally refers to requiring more than one element to access and/or control a computing system. This can make it more difficult or impossible for bad actors to access and/or control the computing systems of others if they do not have all such elements. The present application discloses systems and methods for securely generating, storing, and accessing passwords utilizing multi-factor security methods. For example, a website shown at a personal computer (PC) could request entry of a password. As discussed further herein, the disclosed systems can provide recall of encrypted passwords from a client device (such as the user's smartphone) via a dongle, both of which (the client device and the dongle) must be in the user's possession to enter the password at the PC. This improves data security because, for example, if the smartphone was misplaced or stolen, access to a requesting device could not occur because the disclosed systems require the use of the dongle which must be in communication with the missing smartphone to provide the password to the requesting device.

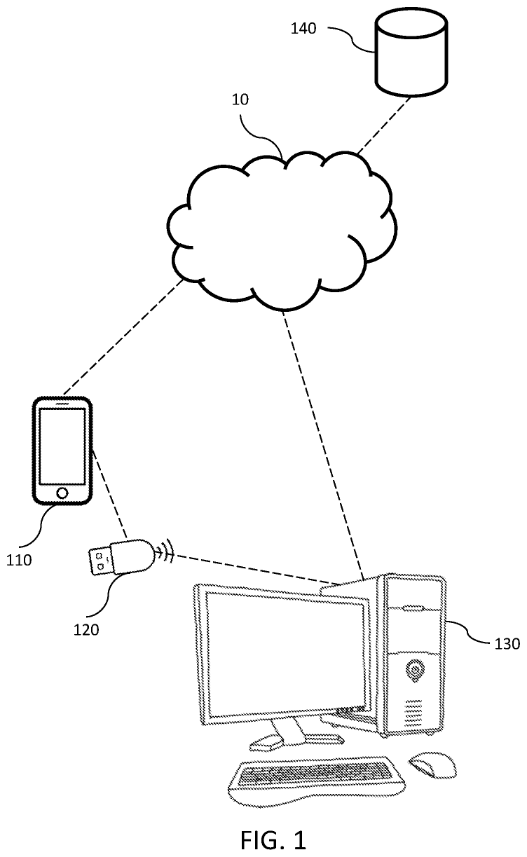

FIG. 1 illustrates an exemplary system for password management for websites accessed via a computing device. As shown in FIG. 1, a system for multifactor password creation and provisioning can include a client computing device 110 (e.g., depicted in FIG. 1 as a smartphone, but could also be a tablet computer, PC, etc.), a dongle 120, and a computing system 130 (e.g., depicted in FIG. 1 as a PC, but could also be a smartphone, tablet computer, etc.). Also depicted in FIG. 1 is a central server 140 (which may be any combination of remote computing systems), which as explained further herein, can be used to store password configurations associated with certain websites, user account data, etc. The devices shown in FIG. 1 can be connected via a network 10 which can be, for example, the Internet, a cellular network, a local area network, etc. Examples of communication links, which may be wired or wireless, are depicted in FIG. 1 as dashed lines. Any combination of communication links between any of the disclosed devices can be present at any time.

As used herein, the term “website” refers to any application, program, etc. that utilizes passwords. While one example can be internet web pages enabling applications such as e-mail or video chat, other examples can include user logins, administrative privileges, locked documents, etc.

As used herein, the term “dongle” refers to any electronic device that is configured to perform the capabilities of the “dongle” as disclosed. In one implementation, the dongle can be a small electronic device that can contain wireless transmission/receiver hardware to allow communication with nearby electronic devices (e.g., via low-energy Bluetooth™), cellular connections, or a wireless connection (e.g., WiFi) to another networked device. Also, some embodiments of the dongle can include hardware ports that allow a physical connection to another device, for example, a Universal Serial Bus (USB) prong such that the dongle can be plugged into a computing system such as a PC. Other embodiments of the dongle can include other kinds of wired hardware or data cables as known in the art to allow communication with other devices.

In some embodiments, implementation of the disclosed methods can be performed via interaction with an app (e.g. a mobile application running on a smartphone). Securely accessing and using a password with some implementations of the disclosed systems can include selecting a password at a user interface (e.g., a touchscreen) of the client computing device. The client computing device can recall an encrypted password from the client computing device's memory based on the selection and transmit the encrypted password to the dongle. The dongle can decrypt the encrypted password received from the client computing device and transmit the decrypted password to a computing system or client computing device. This transmitting can, in one or more embodiments, thus be to a computing system, client computing device, or both. The computing system can then enter the decrypted password. Such entering can be performed automatically by the system in the background (e.g., without displaying entered characters or other graphical representations on a screen), can be entered by the system in the form of letters, numbers, or any characters into a password field displayed at a graphical interface, may be entered by via user input into a similar password field, etc. As previously mentioned, because this process requires both the dongle and the client device, authorized access requires both devices. Described below are further details of exemplary processes for generating secure passwords and recalling/using secured passwords with a desired computing system or client computing device.

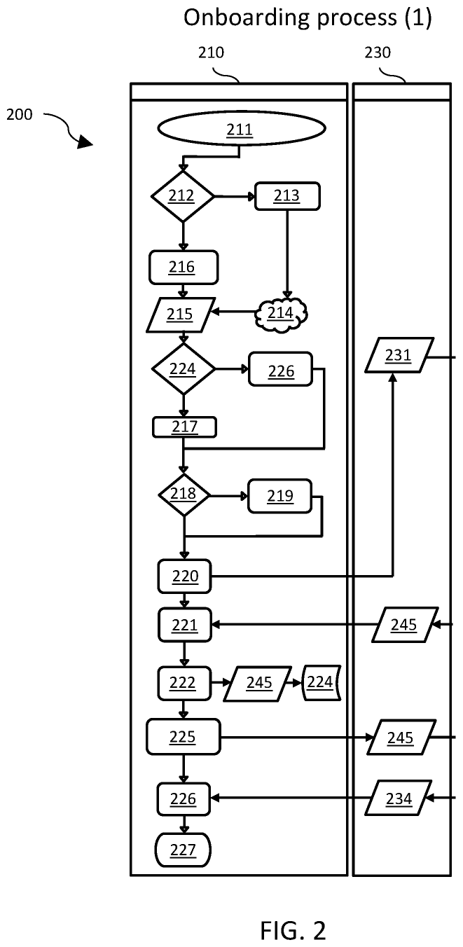

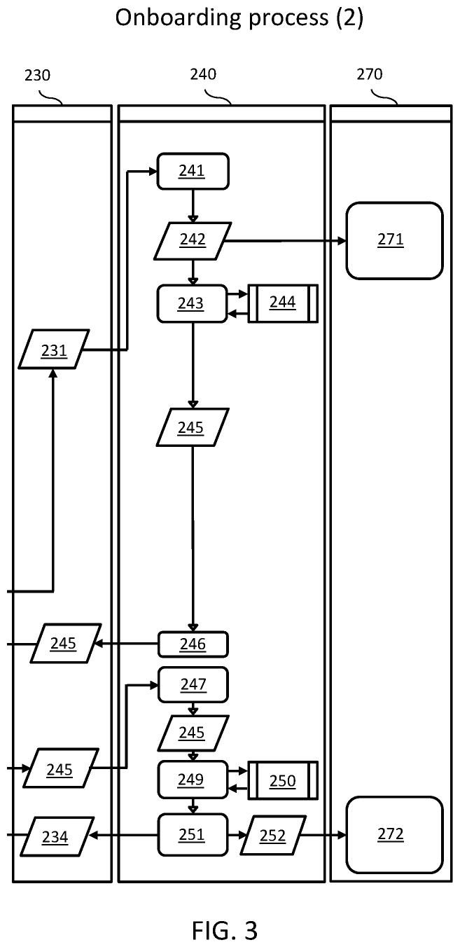

FIGS. 2 and 3 illustrate an exemplary process flow chart for embodiments of the disclosed systems configured to provision passwords for use with a website. The process 200 is grouped according to client computing device operations 210, transmitted data 230, dongle operations 240, and computing system operations 270. FIG. 3 is a continuation of FIG. 2, with some elements reproduced to improve clarity.

In some embodiments, the process can begin with an application or program (hereinafter referred to as an “application”) running on the client computing device. At 211, the application can prompt the user to add a new entry to a website list. Identification of the desired website can be performed by, for example, obtaining the URL of a website currently being viewed on the computing system or the client computing device. The other implementations, the user can select, from an existing list of websites, the website that they want to make a password for.

In many cases, websites have password configurations that are a specific format or requirements for their passwords. For example, password configurations can include a minimum number of characters, a certain number and/or type of “strong” characters (e.g., numbers, special characters such as punctuation, etc.) In one implementation, the list of websites can be provided via the application where the password configuration for those websites are known. The password configurations can be known via the system accessing a database, located for example at the central server, containing a list of websites and their password configurations. The website list and associated password configurations can be stored locally on the client computing device or downloaded from the central server. The system can compare, at 212, the desired website with the website list to determine if the desired website is on the list and hence the password configuration is known.

At 213, if the password configuration is known, then the central server can be accessed 214 to retrieve the password configuration 215. If the password configuration is not known, then at 216 the application can prompt the user to specify password configuration 215. Thus, the system can receive, at the client computing device via user input (e.g., keying in at a touchscreen, via keyboard input, etc.), a password configuration.

At 218, the system can allow the user to generate, at 219, a password (if the website and/or password configuration is unknown) or, alternatively, the system can generate, at 220 by the client computing device, an unencrypted password 231 conforming to the password configuration. The generation can be performed by selecting random characters conforming to the password configuration. As used herein, the term “unencrypted” refers to a password that has never been encrypted (e.g., a newly generated password). The term “encrypted” refers to a password that is encrypted such as with an encryption program and therefore generally not human-readable and/or modified to be difficult to determine without an encryption key. The term “decrypted” refers to a password that was previously encrypted but has since been decrypted to take it back to a state prior to an encryption. With a newly generated password for the website, the client computing device can then transmit, via either a wired or wireless connection, the unencrypted password 231 to the dongle.

As shown in FIG. 3, the process can include, at 241, the dongle receiving the unencrypted password 242 from the client computing device. In one implementation, the process can include, at 271, transmitting the unencrypted password from the dongle to the computing system. For example, the unencrypted password can be received and entered as keystrokes in a password entry field at the computing system (as if the user had typed it in directly at the computing system).

The process can also include, at 243, the dongle encrypting the unencrypted password. The encryption can be performed by, for example, encryption chip 244 in the dongle to generate encrypted password 245. As used herein, the term “chip” refers to any hardware needed for encryption/decryption operations, and such may be on one computer chip or distributed on any number of chips or other infrastructure, such as being circuitry that is not embodied as a “chip” per se. The encryption chip can be a dedicated encryption chip, for example the WB55 platform (dongle hardware) manufactured by STMicroelectronics™, connected to the STSafe™ encryption chip. The STSafe chip can implement any of the following encryption/decryption algorithms for use with the disclosed methods: AES-128 (Advanced Encryption Standard 128 bit), AES-256 (Advanced Encryption Standard 256 bit), Elliptic curve Diffie-Hellman (ECDH). In some embodiments, the STSafe chip can pair and lock to the WB55 device to become a pair that cannot subsequently be broken once connected. The WB55 can then provide any of the above encryption methods implemented in hardware. The WB55 may then sends the password to the STSafe chip along with a command to either encrypt or decrypt the data and wait for the encrypted or decrypted data to come back from the security chip. Once the WB55 receives the result, it can forward it to either the smartphone (if the encrypted password is to be stored during onboarding a new password), or the decrypted password to the computing system (if the dongle is to provide a previously-stored password).

In some implementations, the above can be implemented in software but utilizing the dongle hardware. For example, using the Espressif ESP32 platform, software encryption algorithms (AES-128, AES-192, AES-256, ECDH, etc.) could be used. The required encryption/decryption keys can be stored on the dongle with a matching pair stored on the smartphone. This implementation can be slightly less secure with respect to potentially reverse engineering the decryption software and scraping the key off the dongle. However, this still requires possession of the dongle to do so and would still be very difficult, especially since the ESP32 provides methods to encrypt its own flash memory. In other embodiments, this slight risk could also be mitigated by connecting the ESP32 chip with yet another hardware encryption chip.

The above hardware and software solutions describe only some implementations, and other hardware for encryption/decryption of passwords can be used instead or in addition to the above. In general, such encryption/decryption systems and processes can include the generation of a cryptographic key to transform the unencrypted password into an encrypted password by the encryption software stored on the dongle. Another encryption feature can be to “salt” the unencrypted password so as to add random (or otherwise auto generated) data values to the password to make it more unique. The salted password can then be encrypted via a key or hash as described above.

With the password encrypted, the dongle can transmit, at 246, the encrypted password 245 to the client computing device. Again, such transmission can be performed wirelessly or the dongle can be physically connected to the computing system and the transmission performed via the physical connection. For example, the physical connection can be a USB connection and so the dongle can include a USB plug to facilitate the USB connection.

Returning to FIG. 2, the encrypted password 245 received at 221 can be stored in a computer memory 224 of the client computing device. In some implementations, to improve the security of storing the encrypted password at the client computing device, at 222, the unencrypted password 231 that was sent to the dongle (and thus likely retained in computer memory of the client computing device) can be erased from the client computing device's computer memory.

In some embodiments, after the establishment and storing of the encrypted password, the application at the client computing device can, at 225, optionally request the user to verify the password at the website. The verification process can include transmitting the encrypted password 245 from the client computing device such that it can be received, at 247, by the dongle as shown in FIG. 3. The dongle can then, at 249, decrypt the encrypted password 245 by, for example, reversing the steps used in the encryption methods described above to generate a decrypted password.

Using the methods described previously as an example (AES-128/192/256, ECDH), the encryption method generates ciphertext (the encrypted password) which gets stored on the smartphone. To retrieve the plaintext password after the smartphone sends the request along with the ciphertext of the desired password, the ciphertext can then be decrypted back into the plaintext password using one of the software algorithms mentioned above, or via an encryption chip implementing some of the same algorithms in hardware.

The decryption may include utilizing the same encryption hardware/software (e.g., 244 and 250 being the same encryption hardware/software) or may be done with separate decryption hardware/software in the dongle (e.g., 244 being encryption hardware/software and 250 being decryption hardware/software). At 251, the decrypted password 252 can then be transmitted to the computing system and, at 272, entered into a password verification field similar to the method described above for the initial password entry. In some implementations, the process can include, also at 251, transmitting a confirmation message 234 to the client computing device. The confirmation message can be a human-readable message or can be other data that indicates a successful verification or the transmission of the decrypted password to the website (regardless of whether verification was successful). In some implementations, the application at the client computing device can inform the user, at 226, (e.g. via graphical display) that the password was successfully sent to the computing system, after which the process may, at 227, end.

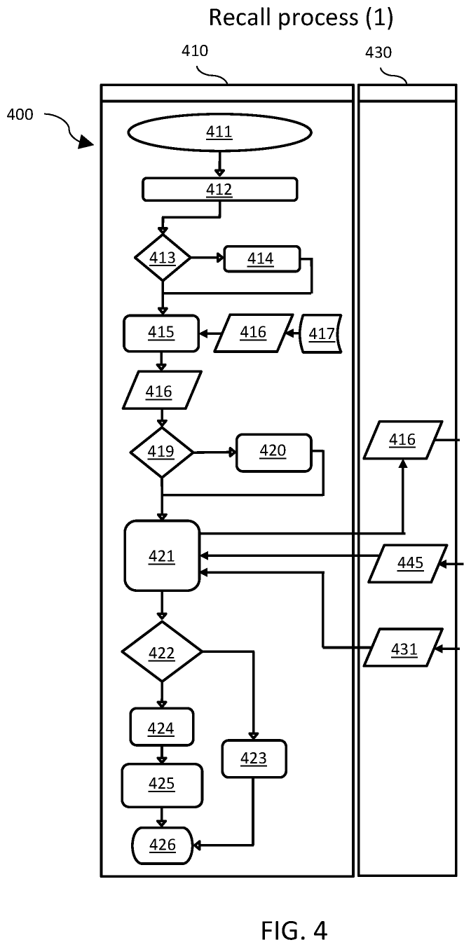

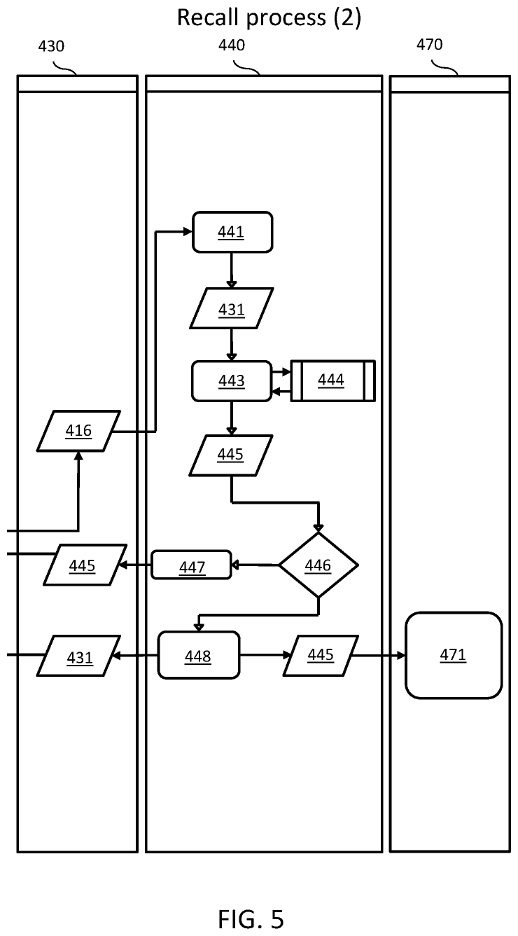

FIGS. 4 and 5 illustrate an exemplary process flow chart for embodiments of the disclosed systems configured to recall passwords for use with a website. The process 400 is grouped according to client computing device operations 410, transmitted data 430, dongle operations 440, and computing system operations 450. FIG. 5 is a continuation of FIG. 4, with some elements reproduced to improve clarity.

With the establishment of encrypted passwords present on the client computing device, a disclosed system can be utilized to securely recall an encrypted password and enter it on a website. As shown in FIG. 4, an exemplary process can begin at 411 with initiation of the application at the client computing device. One initiated, the application can generate, at 412, a message at the user interface of the client computing device requesting the user to either select from a list of stored websites or create a new website/password entry. The selection can be facilitated by the generation of a drop-down menu or other method of listing available websites. Based on the determination, at 413, of whether the website is a new entry, if the new entry option is selected, at 414, creation of the encrypted password can be performed as above. Otherwise, if it is not a new entry (i.e., a selection was made from the stored websites list) implementations of the password recall process can proceed as described further herein. Thus, based on the website selection, at 415, the client computing device can recall the corresponding encrypted password 416 from client computing device memory 417.

The password recall process can include the client computing device transmitting the encrypted password to the dongle for decryption. However, in some implementations, prior to sending, at 421, the encrypted password 416 from the client computing device to the dongle for decryption, the process can, at 419, include determining whether there is a communication link between the client computing device and the dongle. If there is no communication link, or the communication link is not sufficiently strong or stable enough, the client computing device and/or dongle can establish, at 420, the required communication link. This can include, for example, establishing a Bluetooth connection or establishing a physical communication link between the client computing device and the dongle before, at 421, sending the encrypted password 431 to the dongle. As shown in FIG. 5, at 443, decryption of the encrypted password 416 received, at 441, from the client computing device can be performed by the dongle similar to other decryption operations described herein (e.g., utilizing decryption chip 444—which may be the same as decryption chip 250).

Utilization of the decrypted password can, in some implementations, be dependent upon how the dongle is being used (e.g., if the website is on a computing system and the dongle is acting in its capacity as a keyboard, or if the website is on the client computing device and the dongle is acting as only an encryption/decryption). With the determination at 446 that the dongle is being used as an encryption/decryption device, the decrypted password 445 can be transmitted, at 447, to the client computing device (e.g., as a plain text password). As shown in FIG. 4, the client computing device can check, at 422, to see whether the decrypted password was received or whether a confirmation message was received. If it was the decrypted password that was received, the decrypted password can be written to a memory buffer accessible for a copy/paste operation. Optionally, the process can include, at 425, informing the user (e.g. via a graphical display at the client computing device) that the decrypted password is available for pasting into the password field, after which the process may, at 426, end. Returning to FIG. 5, in implementations where the dongle is acting as a keyboard, the decrypted password 445 can, at 448, be converted to keystrokes at the dongle and sent to the computing system. For example, in some implementations, the dongle can appear to the client device just like a wired USB or other connection keyboard, or a wireless keyboard via bluetooth or other wireless means. The dongle can send the keycodes to the client device as if a user was pressing keys on a keyboard. Accordingly, the client device is unable to differentiate between the dongle and an actual keyboard and thus the disclosed methods are compatible with any website or software that allows for password entry via keyboard.

At 471, the keystrokes can then be entered at the computing system in the website password field. Optionally, at 448, a confirmation message 431 can be transmitted from the dongle to the client computing device (e.g., similar to the confirmation message described above).

If it was determined at 422 that the confirmation message 431 that was received, the application at the client computing device can inform the user, at 423, (e.g. via graphical display) that the password was successfully sent to the computing system, after which the process may, at 426, end.

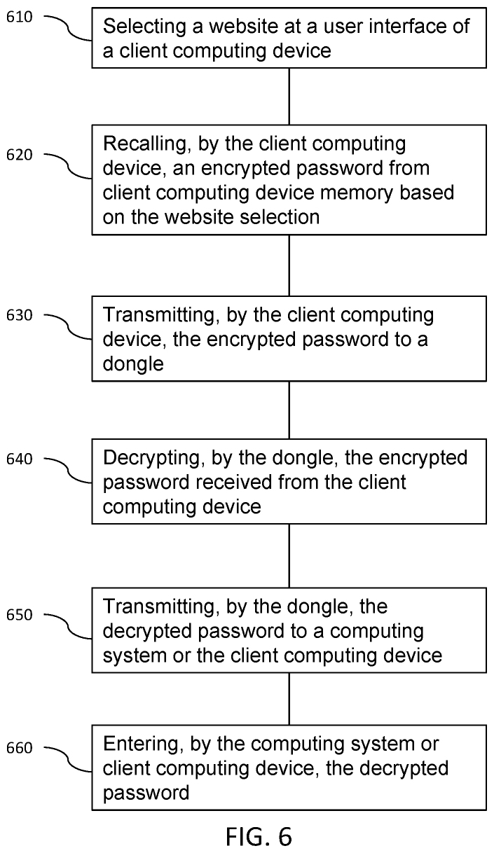

FIG. 6 is a simplified process flow diagram of an exemplary method in accordance with certain aspects of the present disclosure.

The method can include, at 610, selecting a website at a user interface of the client computing device.

The method can further include, at 620, recalling, by the client computing device, an encrypted password from client computing device memory based on the website selection.

The method can further include, at 630, transmitting, by the client computing device, the encrypted password to the dongle.

The method can further include, at 640, decrypting, by the dongle, the encrypted password received from the client computing device.

The method can further include, at 650, transmitting, by the dongle, the decrypted password to the computing system or the client computing device.

The method can further include, at 660, entering, by the computing system or client computing device, the decrypted password.

The illustrated method can optionally be embodied as part of a system, or as a computer program product (non-transitory medium or software). The elements of the disclosed method need not all be present in the method nor necessarily be performed in the order presented. In particular, some devices, such as the dongle, can include software that enables 640 and 650, and such embodiments may not utilize the other method elements.

In the following, further features, characteristics, and exemplary technical solutions of the present disclosure will be described in terms of items that may be optionally claimed in any combination:

Item 1: A dongle for encrypting and/or decrypting passwords, the dongle comprising: at least one programmable processor; and a non-transitory machine-readable medium storing instructions which, when executed by the at least one programmable processor, cause the at least one programmable processor to perform operations comprising: decrypting an encrypted password received from a client computing device; and transmitting the decrypted password to a computing system or the client computing device.

Item 2: The dongle of Item 1, the operations further comprising: writing, to a memory buffer accessible for a copy/paste operation, the decrypted password.

Item 3: The dongle of any one of the preceding Items, the operations further comprising: receiving an unencrypted password from the client computing device; and transmitting the unencrypted password from the dongle to the computing system.

Item 4: The dongle of Item 3, the operations further comprising: encrypting the unencrypted password; and transmitting the encrypted password to the client computing device.

Item 5, The dongle of Item 4, wherein the transmitting is performed wirelessly.

Item 6: The dongle of any one of the preceding Items, wherein the dongle is physically connected to the computing system.

Item 7: The dongle of any one of the preceding Items, wherein the physical connection is via a USB connection and the dongle further comprises a USB plug to facilitate the USB connection.

Item 8: The dongle of any one of the preceding Items, the operations further comprising transmitting a confirmation message to the client computing device.

Item 9: A computer program product comprising a non-transitory, machine-readable medium storing instructions which, when executed by at least one programmable processor, cause the at least one programmable processor to perform operations from any one of the preceding Items.

Item 10: A system for multifactor password creation and provisioning, the system comprising: a client computing device; a dongle; a computing system; and a non-transitory machine-readable medium storing instructions which, when executed by the at least one programmable processor, cause the at least one programmable processor to perform operations comprising: selecting a website at a user interface of the client computing device; recalling, by the client computing device, an encrypted password from client computing device memory based on the website selection; transmitting, by the client computing device, the encrypted password to the dongle; decrypting, by the dongle, the encrypted password received from the client computing device; transmitting, by the dongle, the decrypted password to the computing system or the client computing device; and entering, by the computing system or client computing device, the decrypted password.

Item 11: A system for multifactor password creation and provisioning, the system comprising: a client computing device; a dongle; a computing system; and a non-transitory machine-readable medium storing instructions which, when executed by the at least one programmable processor, cause the at least one programmable processor to perform operations comprising: selecting a website at a user interface of the client computing device; recalling, by the client computing device, an encrypted password from client computing device memory based on the website selection; transmitting, by the client computing device, the encrypted password to the dongle; decrypting, by the dongle, the encrypted password received from the client computing device; transmitting, by the dongle, the decrypted password to the computing system or the client computing device; and entering, by the computing system or client computing device, the decrypted password.

Item 12: The system of Item 11, the operations further comprising: receiving, at the client computing device via user input, a password configuration; and generating, by the client computing device, an unencrypted password conforming to the password configuration.

Item 13: The system of any of Items 11-12, wherein the selecting comprises generating a graphical element at a graphical user interface of the client device, the graphical element associated with the password.

Item 14: The system of any of Items 11-13, the operations further comprising: writing, to a memory buffer in the dongle accessible for a copy/paste operation, the decrypted password.

Item 15: The system of any of Items 11-14, the operations further comprising: transmitting, by the client computing device to the dongle, an encrypted password; decrypting, by the dongle, the encrypted password to generate a decrypted password; and transmitting, by the dongle, the decrypted password to the computing system.

Item 16: The system of any of Items 11-15, the operations further comprising transmitting a confirmation message to the client computing device.

Item 17: A computer program product comprising a non-transitory, machine-readable medium storing instructions which, when executed by at least one programmable processor, cause the at least one programmable processor to perform operations from any one of the preceding Items 11-16.

The present disclosure contemplates that the calculations disclosed in the embodiments herein may be performed in a number of ways, applying the same concepts taught herein, and that such calculations are equivalent to the embodiments disclosed.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” (or “computer readable signal”) refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, computer programs and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. The implementations described above can be directed to various combinations and subcombinations of the disclosed features and/or combinations and subcombinations of further features noted above. Furthermore, above described advantages are not intended to limit the application of any issued claims to processes and structures accomplishing any or all of the advantages.

Additionally, section headings shall not limit or characterize the invention(s) set out in any claims that may issue from this disclosure. Further, the description of a technology in the “Background” is not to be construed as an admission that technology is prior art to any invention(s) in this disclosure. Neither is the “Summary” to be considered as a characterization of the invention(s) set forth in issued claims. Furthermore, any reference to this disclosure in general or use of the word “invention” in the singular is not intended to imply any limitation on the scope of the claims set forth below. Multiple inventions may be set forth according to the limitations of the multiple claims issuing from this disclosure, and such claims accordingly define the invention(s), and their equivalents, that are protected thereby.

What is claimed is:

1. A dongle for encrypting and/or decrypting passwords, the dongle comprising:
at least one programmable processor; and
a non-transitory machine-readable medium storing instructions which, when executed by the at least one programmable processor, cause the at least one programmable processor to perform operations comprising:
decrypting an encrypted password received from a client computing device; and
transmitting the decrypted password to a computing system or the client computing device.

2. The dongle of claim 1, the operations further comprising:
writing, to a memory buffer accessible for a copy/paste operation, the decrypted password.

3. The dongle of claim 1, the operations further comprising:
receiving an unencrypted password from the client computing device; and
transmitting the unencrypted password from the dongle to the computing system.

4. The dongle of claim 3, the operations further comprising:
encrypting the unencrypted password; and
transmitting the encrypted password to the client computing device.

5. The dongle of claim 4, wherein the transmitting is performed wirelessly.

6. The dongle of claim 1, wherein the dongle is physically connected to the computing system.

7. The dongle of claim 1, wherein the physical connection is via a USB connection and the dongle further comprises a USB plug to facilitate the USB connection.

8. The dongle of claim 1, the operations further comprising transmitting a confirmation message to the client computing device.

9. A computer program product comprising a non-transitory, machine-readable medium storing instructions which, when executed by at least one programmable processor, cause the at least one programmable processor to perform operations comprising:
decrypting an encrypted password received from a client computing device; and
transmitting the decrypted password to a computing system or the client computing device.

10. The computer program product of claim 9, the operations further comprising:
writing, to a memory buffer accessible for a copy/paste operation, the decrypted password.

11. The computer program product of claim 9, the operations further comprising:
receiving an unencrypted password from the client computing device; and
transmitting the unencrypted password from a dongle to the computing system.

12. The computer program product of claim 11, the operations further comprising:
encrypting the unencrypted password; and
transmitting the encrypted password to the client computing device.

13. The computer program product of claim 12, wherein the transmitting is performed wirelessly.

14. The computer program product of claim 9, the operations further comprising transmitting a confirmation message to the client computing device.

15. A system for multifactor password creation and provisioning, the system comprising:
a client computing device;
a dongle;
a computing system; and
a non-transitory machine-readable medium storing instructions which, when executed by at least one programmable processor, cause the at least one programmable processor to perform operations comprising:
selecting a website at a user interface of the client computing device;
recalling, by the client computing device, an encrypted password from client computing device memory based on the website selection;
transmitting, by the client computing device, the encrypted password to the dongle;
decrypting, by the dongle, the encrypted password received from the client computing device;
transmitting, by the dongle, the decrypted password to the computing system or the client computing device; and
entering, by the computing system or the client computing device, the decrypted password.

16. The system of claim 15, the operations further comprising:
receiving, at the client computing device via user input, a password configuration; and
generating, by the client computing device, an unencrypted password conforming to the password configuration.

17. The system of claim 15, wherein the selecting comprises generating a graphical element at a graphical user interface of the client device, the graphical element associated with the password.

18. The system of claim 15, the operations further comprising:
writing, to a memory buffer in the client device accessible for a copy/paste operation, the decrypted password.

19. The system of claim 15, the operations further comprising:
transmitting, by the client computing device to the dongle, an encrypted password;
decrypting, by the dongle, the encrypted password to generate a decrypted password; and
transmitting, by the dongle, the decrypted password to the computing system.

20. The system of claim 15, the operations further comprising transmitting a confirmation message to the client computing device.

21. The system of claim 15, the operations further comprising:
receiving, at the dongle, an unencrypted password from the client computing device; and
transmitting the unencrypted password from the dongle to the computing system.

22. The system of claim 21, the operations further comprising:
encrypting, by the dongle, the unencrypted password; and
transmitting, by the dongle, the encrypted password to the client computing device.

23. The system of claim 22, wherein the transmitting from the dongle to the client computing system is performed wirelessly.

24. The system of claim 15, wherein the dongle is physically connected to the computing system.

25. The system of claim 24, wherein the physical connection is via a USB connection and the dongle further comprises a USB plug to facilitate the USB connection.
